(19) United States
(12) Patent Application Publication
(10) Pub. No.: US 2003/0230728 A1
(43) Pub. Date: Dec. 18, 2003

(54) Multiwavelength transilluminator for absorbance and fluorescence detection using light emitting diodes

(76) Inventors: Zhengshan Dai, Chapel Hill, NC (US); Xue-Feng Wang, Chapel Hill, NC (US); Richard Sheridan, Cary, NC (US)

Correspondence Address: SHERIDAN ROSS PC, 1560 BROADWAY, SUITE 1200, DENVER, CO, 80202

(21) Appl. No.: 10/460,580

(22) Filed: Jun. 11, 2003

Related U.S. Application Data
(60) Provisional application No. 60/405,843, filed on Aug. 26, 2002.
(60) Provisional application No. 60/388,191, filed on Jun. 13, 2002.

(51) Int. Cl. G01N 21/64

(52) U.S. Cl. 250/458.1

(57) ABSTRACT

Systems, devices and methods are provided for viewing a pattern of biological material stained with dyes capable of absorbing, scattering or fluorescing light when illuminated by light emitting diodes (LEDs). The system includes a light source containing multiple light source arrays of different LED types emitting light at different wavelengths optimized for detecting specific dyes, a diffuser, a detector or viewer, and optional optical filters to ensure that the only light reaching the detector or viewer is light produced by fluorescence of the various dyes within a specific wavelength band. The optical filters are optional for detecting or viewing absorbance and light scatter. The different arrays of LED types can be selected in any combination during illumination and their intensity is adjustable over a range from 0-100%. A system and method is also provided for comparing patterns for two or more dyes contained in a single material.

### CROSS REFERENCE TO RELATED APPLICATIONS

This application claims the benefit of U.S. Provisional Patent Application Serial No. 60/405,843, filed Aug. 26, 2002, entitled MULTIWAVELENGTH TRANSILLUMINATOR FOR ABSORBANCE AND FLUORESCENCE DETECTION USING LIGHT EMITTING DIODES, and U.S. Provisional Patent Application Serial No. 60/388,191, filed Jun. 13, 2002, entitled AUTOMATED PROTEIN GEL PROCESSING METHODS AND SYSTEM, the disclosures of which are incorporated herein by reference in their entirety.

### FIELD OF THE INVENTION

The present invention is directed to a method and apparatus for illuminating biological substrates for the purpose of viewing and detecting patterns of absorbance and fluorescence on said biological substrate. In particular, the present invention is directed to the use of light emitting diodes (LEDs) as light sources in a multiple wavelength transillumination system.

### BACKGROUND OF THE INVENTION

The separation of proteins, nucleic acids and other biological materials by gel electrophoresis on polyacrylamide or agarose matrices is a standard technique in molecular biology (Westermeier, R. and Barnes, N., Electrophoresis in Practice: A Guide to Methods and Applications of DNA and Protein Separations 3rd edition, Vch Verlagsgesellschaft Mbh, 2001). A common method for analyzing these gels after electrophoresis is to immerse the gels in a solution containing a dye that binds to all or some of the separated materials. The gels are then destained to remove any unbound dye and the gel is placed on a transilluminator for viewing. The transilluminator emits light of a specific wavelength that is absorbed by the dye. Depending on the dye, it may or may not re-emit light at a longer wavelength (i.e., fluorescence). If the dye absorbs light but does not fluoresce, the stained material appears dark against a background of transmitted light (Sasse, J., and Gallagher, S. R., Current Protocols in Molecular Biology Unit 10.6, Ausubel, F. A., et al., eds., Wiley-Interscience, 1991). If the dye fluoresces and an optical filter is used to block the source light and to pass the emitted light, the stained material appears light against a dark background (Nucleic Acid Detection, TCO167, Molecular Probes Inc. 2000; Tools For Proteomics, TC0158-2, Molecular Probes Inc. 2002). These patterns can be detected and documented using a variety of techniques including photography using a camera with film and, more recently, imaging using a CCD camera.

Transilluminators used in the art to visualize dyes that absorb or fluoresce are described in a number of patents. The term “transilluminator” as used herein means a device which generates light and allows the light to pass through a diffuser or filter onto which a material has been placed and permits viewing of the material and any pattern generated in or on the material by the action of the light passing through or impinging on the material that is visible to the viewer or detector. Transilluminators are typically comprised of an open enclosure that houses a light source and a diffuser or filter that covers the light source and transmits light emitted by the source. A gel is placed on the diffuser or filter and light impinges on the gel. A detector or viewer is then used to record the pattern of absorbance or fluorescence caused by the interaction of the light and the dye used to stain the material in the gel. A variety of filters may be used to modify the light emitted by the light source or the dyes in order to enhance detection or viewing. Transilluminators that use a high intensity ultra-violet (UV) light source primarily for viewing nucleic acid gels stained with fluorescent dyes are described in U.S. Pat. Nos. 5,327,195, 4,657,655, and 5,347,342. A multiple wavelength UV transilluminator that contains three different lamps that cover the short, mid and long UV wavelengths is described in U.S. Pat. No. 5,387,801. A transilluminator capable of both UV and visible light illumination using interchangeable lamps is described in U.S. Pat. No. 4,071,883. Alternatively, a screen that can be placed on a UV transilluminator to convert UV to visible light is described in U.S. Pat. No. 5,998,789. More recently, a transilluminator for fluorometric detection using visible light generated from fluorescent lamps that emit in the blue spectrum is described in U.S. Pat. Nos. 6,198,107 and 6,512,236.

Historically, high intensity UV transilluminators were designed and developed to view nucleic acid gels stained with fluorescent dyes such as ethidium bromide. UV light for viewing gels has two major disadvantages: 1) exposure of humans viewing gels to intense UV light is hazardous and requires protection to eyes and skin to avoid damage and 2) exposure of biomolecules in gels to intense UV light can induce damage or adduct formation that can irreversibly alter the structure and function of the molecules making further study difficult.

In addition, not all fluorescent dyes, especially those used to stain proteins, absorb optimally in the UV region (Haugland, R., Handbook of Fluorescent Probes and Research Products, Ninth Edition, Molecular Probes, Inc., 2002). A transilluminator for fluorometric detection using visible light generated from fluorescent lamps filtered to emit light in the blue spectrum is described in U.S. Pat. Nos. 6,198,107 and 6,512,236. However, this device is limited to a specific set of fluorescent dyes that absorb in the blue region.

With the advent of proteomics, the most widely adopted method for studying proteins is two-dimensional gel electrophoresis (2DE). Proteins separated by 2DE are visualized by a variety of staining methods using visible dyes such as silver and Coomassie Blue and fluorescent dyes such as SYPRO Ruby and the CyDyes used for fluorescence 2D difference gel electrophoresis (2D DIGE).

### SUMMARY OF THE INVENTION

In accordance with an embodiment of the present invention, a transilluminator for 2DE protein gels that is capable of viewing gels stained by any of a number of methods is provided. In particular, embodiments of the present invention provide a multi-wavelength transilluminator and methods for viewing and detecting patterns of light scattering, absorbance and fluorescence for a variety of staining technologies within a single device. The light source may be an array of high intensity narrow emission band light emitting diodes (LEDs) matched to the absorbance spectra of each dye type. The transilluminator includes a light source containing multiple LEDs emitting light at various wavelengths optimized for detecting specific dyes and an optical filter to ensure that the only light reaching the detector or viewer is light produced by fluorescence of the dyes. The optical filter is optional for detecting or viewing absorbance. The different LEDs can be selected in any combination during illumination and their intensity is adjustable using pulse width modulation (PWM) over a range from 0-100%.

In accordance with another embodiment of the present invention, a multiple wavelength transillumination system using LEDs as light sources is provided for the viewing and detection of patterns of absorbance and fluorescence. Different LEDs emitting different wavelengths of light are combined in the same device to form a multiple wavelength transillumination system. Different numbers of LEDs are combined to form transilluminators of different sizes. Uniform surface light illumination is achieved by:

placing a diffuser at an optimal distance from the LEDs, selecting LEDs with a sufficiently large angle of illumination and brightness,

spacing LEDs at a sufficient density and in an optimal pattern, and

properly adjusting the intensity of illumination.

In accordance with the present invention, a multiple wavelength transillumination system comprises:

1) a light source consisting of LEDs capable of producing light in any combination of the following:

a) of the excitation type for commonly used fluorescent dyes (i.e., fluorophors) used to stain biomolecules,

b) of the type absorbed by commonly used colorimetric dyes (i.e., chromophors) used to stain biomolecules, and

c) of the type scattered by commonly used particulate dyes used to stain biomolecules.

2) a diffuser placed between the light source and the dyes being viewed or detected;

3) optional optical filter(s) placed between said fluorescent dyes and a viewer or light detector which filter is capable of transmitting light emitted by the fluorescent dyes and of preventing transmission of light from said light source of said excitation type, to form a viewable image of the pattern of fluorescent dyes. In some embodiments, the optical filter may be adapted to be placed over the human eye or may to be attached to the lens of an optical scanner, charge coupled device or camera.

The devices and methods of this invention are especially useful when the user requires viewing, detecting, comparing and imaging of the spatial arrangements of multiple chromophors and fluorophors either contained within the same matrix or contained in different matrices such as 1D and 2D protein and DNA electrophoresis gels, thin-layer chromatography plates (TLC), gel blots, chromatography fractions, arrays, biochips, and other analytical or preparative substrates.

The system of this invention may be incorporated into an integrated device such as a 2D gel processing system, gel documentation system, horizontal or vertical gel electrophoresis unit, scanner, imager or other device in which viewing or detection of absorbance, fluorescence and light scattering is required.

Devices of this invention use LEDs as light sources rather than ultraviolet, incandescent and fluorescent lamps of the types described in the U.S. Pat. Nos. 4,071,883, 4,657,655, 5,327,195, 5,347,342, 5,387,801, 6,198,107 and 6,512,236. Embodiments of the present invention use multiple high intensity, narrow band LEDs with large angles of illumination that permit viewing of several different chromophors and fluorophors. In these embodiments the wavelength(s) and intensity(ies) are selectable either mechanically, electronically or through software. Direct viewing may be accomplished using the human eye or viewing and recording may be accomplished using an imaging device such as a film camera using both conventional photography or a CCD camera as part of a digital imaging system.

### BRIEF DESCRIPTION OF THE DRAWINGS

FIG. 1 is a perspective view of a transillumination device in accordance with an embodiment of the present invention;

FIG. 2 is an exploded view of the device of FIG. 1;

FIG. 3 is a functional block diagram of a transilluminator in accordance with an embodiment of the present invention;

FIG. 4 illustrates an LED circuit diagram comprised of two independent LED circuits in accordance with an embodiment of the present invention;

FIG. 5 illustrates an arrangement of LEDs on a printed circuit board in accordance with an embodiment of the present invention;

FIG. 6 illustrates an arrangement of LEDs on a printed circuit board in accordance with another embodiment of the present invention;

FIG. 7 illustrates a transillumination system in accordance with an embodiment of the present invention; and

FIG. 8 is a flow chart illustrating the operation of a device in accordance with an embodiment of the present invention.

### DETAILED DESCRIPTION

Many dyes fluoresce light within the visible spectrum when illuminated by ultraviolet or visible light. Other dyes absorb or scatter light within the visible spectrum when illuminated by visible light. However, prior to the present invention, there have not been transilluminators capable of viewing or detecting a broad range of dyes within a single device. This is because transilluminators for viewing fluorophors place optical filters on either side of the material to which a fluorophor is bound to narrow the excitation band impinging on the material and to narrow the emission band passing to the detector. This allows the emitted light from the fluorophor to be detected but limits the fluorophors that can be detected since only a single pair of narrow excitation and emission wavelength bands are available. Transilluminators for viewing chromophors that absorb or scatter light use unfiltered white or broad-band visible light which is unsuitable for viewing fluorescent dyes.

The present invention does not require an excitation filter between the light source and the material to which a fluorophor is bound to narrow the excitation band impinging on the material being viewed. Rather it uses high intensity LEDs that emit a narrow band light suitable for direct illumination of the fluorophor. By placing a variety of narrow band LEDs in the same transilluminator and constructing a circuit whereby LEDs of one type can be controlled independently of those of another type, it is possible to construct a transilluminator that can emit a variety of different ultraviolet and visible excitation wavelengths as well as white or broad-band visible light. Furthermore, the circuit can include the capability to adjust intensity and to combine the various wavelengths. The circuit also can be designed so that these adjustments are made manually by a user or under software control. By placing a variety of emission filters between the material being viewed and the detector, many excitation/emission pairs can be supported. In addition, chromophors that absorb or scatter light can also be viewed with the same device.

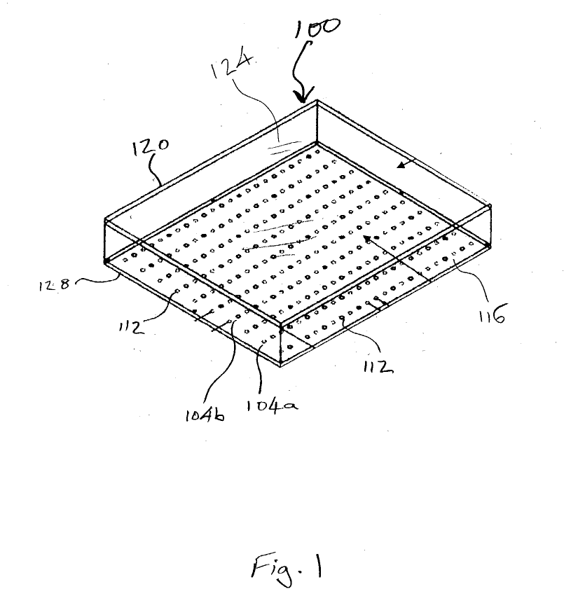

FIG. 1 illustrates the composition of a transilluminator or transillumination device 100 in accordance with an embodiment of the present invention. In general, the transillumination device 100 includes a number of output or light source arrays 104 (e.g., light source arrays 104a and 104b) comprising one or more LEDs 112 that are mounted on a printed circuit board 116 and placed in an enclosure 120. The LEDs 112 may comprise high intensity LEDs having wide angles of illumination (e.g., greater than about 120°). A diffuser 124 is mounted proximate to a side of the printed circuit board 116 from which light from the LEDs 112 is emitted, and a bottom plate 128 may be mounted on the other side of the printed circuit board 116. The diffuser 124, the pattern and density of the LEDs 112 mounted on the printed circuit board 116, the illumination angle of the LEDs 112 and the distance between the diffuser 124 and the printed circuit board 116 all contribute to the uniformity of illumination.

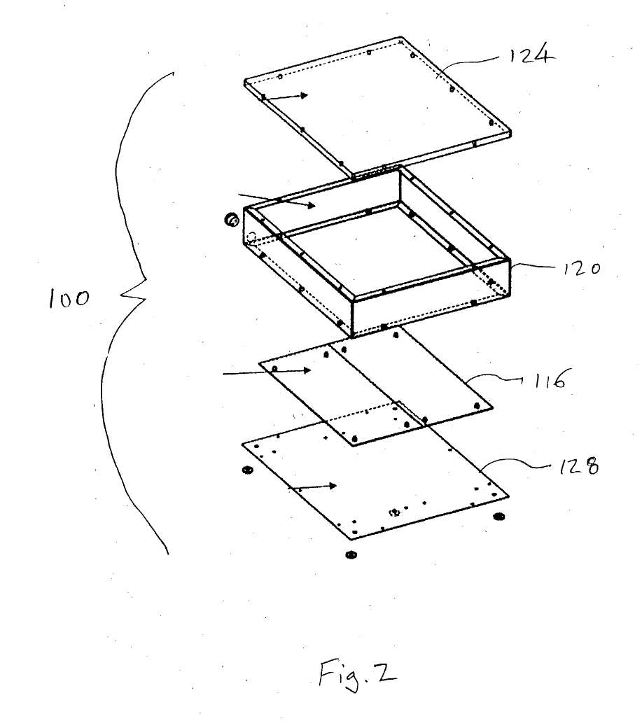

With reference now to FIG. 2, the transillumination device 100 of FIG. 1 is shown in an exploded view. In particular, FIG. 2 illustrates the relationship between the diff-user 124, enclosure 120, printed circuit board 116, and bottom plate 128.

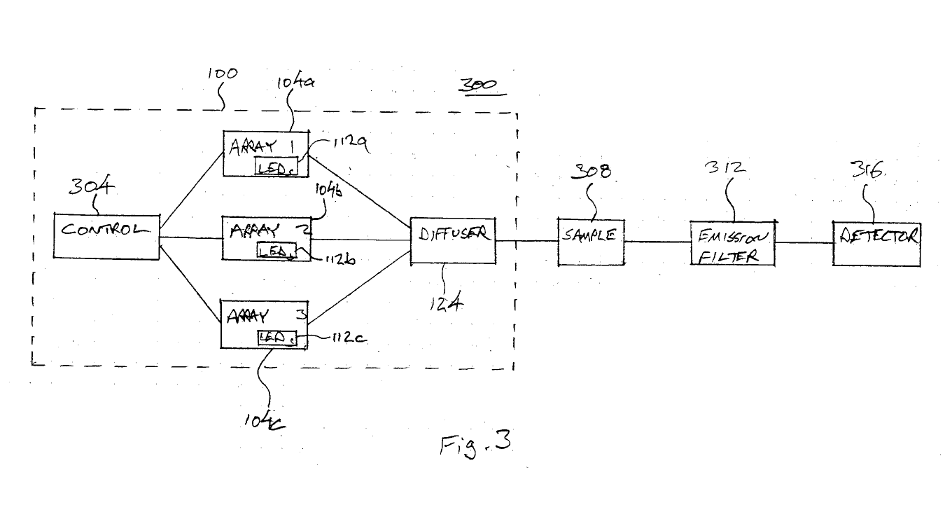

With reference now to FIG. 3, a transillumination system 300 including a transillumination device 100 in accordance with an embodiment of the present invention is illustrated in functional block diagram form. In general, the transilluminator 100 includes a control 304, a first light source array 104a, a second light source array 104b, and a third light source array 104c. In addition, the transillumination device 100 includes a diffuser 124.

The control 304 may comprise a switch for selectively operating the associated light source arrays 104, for example where the transillumination device 100 is under the manual control of an operator. Alternatively or in addition, the control 304 may comprise a programmable device executing instructions regarding the operation of the light source arrays 104. In addition to providing manual or automated switching capabilities, the control 304 may be operated to vary the intensity of the light produced by the light source arrays 104. For example, in accordance with an embodiment of the present invention, the control 304 provides a pulse width modulated signal to a light source array or arrays 104 being operated. As can be appreciated by one of skill in the art, by varying the duty cycle of a signal provided to a light source array 104, the intensity of the light produced by the light source array 104 can be varied. For example, a pulse width modulated signal that was on for 50% of the time in a given time segment would result in a reduced intensity of the light output by a given light source array 104 as compared to a control signal in which the signal to the light source array 104 was on continuously. The ability to modulate the intensity of light output by a light source array 104 is particularly useful in connection with normalizing light received at the detector 316 between different light source arrays 104 and/or samples 308. As can be appreciated by one of skill in the art, the control 304 may control a separate or integrated amplifier for providing power to the light source arrays 104.

Each light source array 104 comprises one or more LEDs 112. In accordance with an embodiment of the present invention, each light source array 104 comprises LEDs 112 that output light at a wavelength or within a range of wavelengths that is different from the light output by LEDs 112 of another light source array 104. Accordingly, the transilluminator 100 can be operated to provide light at a selected wavelength, without requiring the use of an excitation filter between a light source and a sample or the changing of such an excitation filter. In accordance with another embodiment of the present invention, two or more light source arrays 104 may comprise LEDs 112 that output light at the same wavelength or range of wavelengths. Light source arrays 104 so configured may then be selectively operated to vary the intensity of light at the wavelength or range of wavelengths produced by the included LEDs 112. The provision of multiple light source arrays 104 having LEDs at the same wavelength or range of wavelengths to vary intensity may be combined with the modulation of the control signal provided to the LEDs 112.

Light produced by the light source arrays 104 is passed through the diffuser 124. The diffuser 124 functions to diffuse the light, thereby providing substantially even illumination across the operating surface of the transilluminator device 100. In accordance with an embodiment of the present invention, the diffuser 124 is formed from polypropylene.

The sample 308 is positioned on or adjacent the diffuser 124, such that the light produced by a light source array 104 and passed through the diffuser 124 is incident upon the sample 308. As can be appreciated by one of skill in the art, a sample 308 may comprise a biological substrate. Dye that has been bound to biological material on the biological substrate may then be viewed by light from the transillumination device 100 that is passed through or impinges on the material. Light comprising wavelengths resulting from the fluorescence of material being viewed, or light scattered by the material, may be selectively viewed by positioning an emission filter 312 between the sample 308 and the detector 316. The detector 316 may comprise any device capable of detecting the fluorescence, scattering, or absorption of light by the material being visualized. Accordingly, examples of a detector 316 include a human eye, alone or in combination with a microscope, a photosensor device, or imaging device, including an optical scanner or a camera, including a film camera or a charge coupled device (CCD) camera.

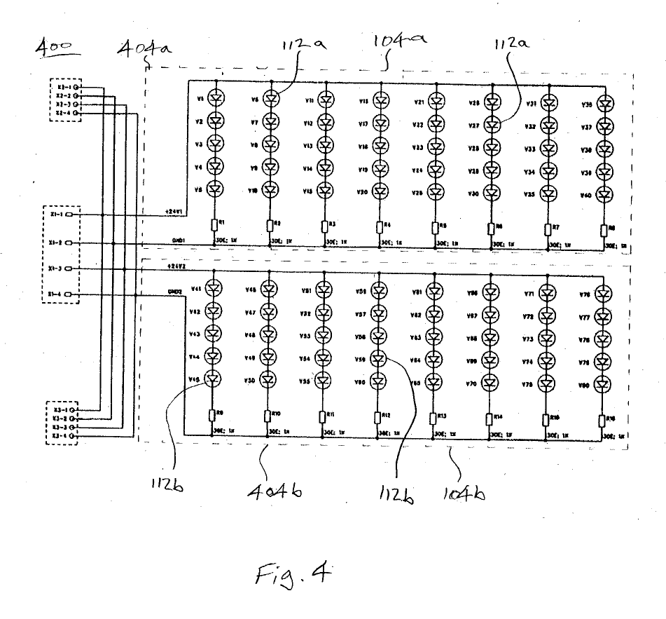

FIG. 4 is a schematic diagram of a light source circuit 400 of a device in accordance with an embodiment of the present invention. In particular, FIG. 4 illustrates that a transillumination device 100 in accordance with embodiments of the present invention may comprise multiple circuits to allow light having different properties to be produced. For example, in FIG. 4, a transillumination device 100, including a light source circuit 400 that has a first light source array 104a comprising a first circuit 404a containing LEDs 112a that emit light within a first wavelength range and a second light source array 104b comprising a second circuit 404b containing LEDs 112b that emit light within a second wavelength range is schematically depicted. As shown in FIG. 4, the first circuit 404a may be operated to illuminate the LEDs 112a of the first light source array 104a and the second circuit 404b may be operated to illuminate the LEDs 112b of the second light source array 104b independently of one another. Accordingly, an embodiment having a light source circuit 400 as illustrated in FIG. 4 may be operated to produce light within either or both of first and second wavelength ranges.

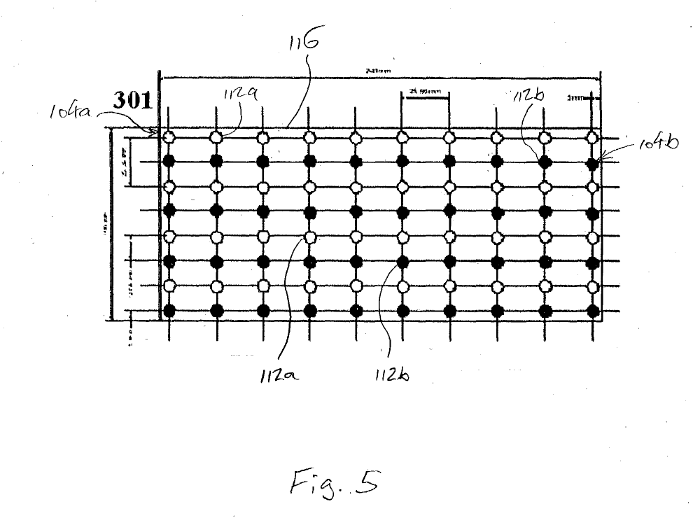

FIG. 5 illustrates an arrangement of LEDs 112 on a printed circuit board 116 in accordance with an embodiment of the present invention. In the embodiment of FIG. 5, rows of LEDs 112a included in a first light source array 104a alternate with rows of LEDs 112b included in a second light source array 104b. The interleaving of LEDs 112aassociated with a first fight source array 104a with LEDs 112b associated with a second light source array 104b provides a transilluminator in which samples can be evenly illuminated by either the first 104a or second 104b light source arrays.

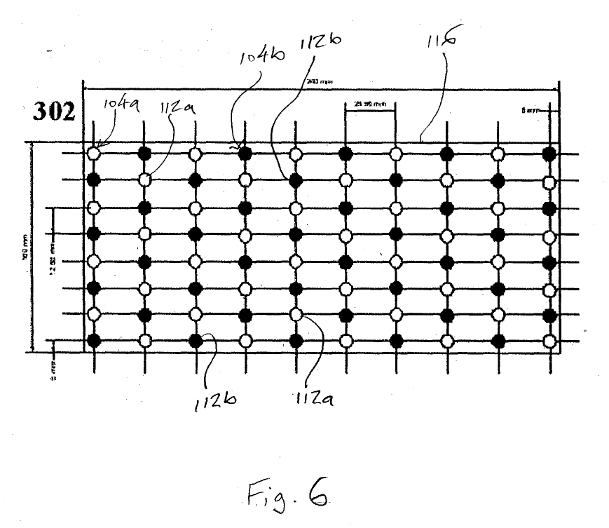

With reference now to FIG. 6, an arrangement of LEDs 112 on a printed circuit board 116 in accordance with another embodiment of the present invention is illustrated. In the embodiment of FIG. 6, the individual LEDs 112a and 112b of the first 104a and second 104b light source arrays respectively are interleaved. As with the embodiment illustrated in connection with FIG. 5, the embodiment illustrated in FIG. 6 provides even illumination of samples by either the first light source array 104a or the second light source array 104b.

In order to optimize the uniformity of illumination provided by a light source array 104, it may be necessary to use still other arrangements of LEDs 112. In particular, the number of different types of LEDs 112 used by a light source array or arrays 104, and the angle and intensity of illumination of the individual types of LEDs 112 may require the use of different LED 112 layouts. Optimal layouts may involve different geometric patterns as well as different numbers of LEDs 112 of each type. In accordance with additional embodiments of the present invention, transilluminators 100 of various sizes can be created by combining 1, 2, 3 . . . n printed circuit boards 116 to make a single light source array or combination of arrays 104.

As can be appreciated by one of skill in the art, a transillumination device 100 may include more than two light source arrays 104 (as depicted in FIGS. 1 and 4-6) or three light source arrays 104 (as depicted in FIG. 3). In particular, in connection with a transilluminator 100 capable of providing excitation light at more than two or three wavelengths or wavelength ranges, additional light source arrays and associated LEDs 112 may be included. For example, in accordance with an embodiment of the present invention, a first light source array 104a comprising LEDs 112 that output light at a first wavelength is combined with a second light source array 104b comprising LEDs 112 that output light at a second wavelength, a third light source array 104 comprising LEDs 112 that output light at a third wavelength and an n^{th} light source array 104 comprising LEDs 112 that output light at an n^{th} wavelength. By providing light source arrays 104 comprising LEDs 112 that are capable of outputting light at different wavelengths, it can be appreciated that different dyes within a sample 308 or in different samples 308 can be observed, particularly when a selected filter 312 is placed between a sample 308 and an observation device or detector 316.

To demonstrate the efficacy of a transillumination system 300 including a transillumination device 100 in accordance with an embodiment of the present invention, a SYPRO Ruby stained 2D protein gel was transilluminated. A fluorescent staining pattern of the fluorophor dye bound to proteins in the gel was observed. In accordance with an embodiment of the present invention, the illumination was achieved using 470 nm Super Blue LEDs 112a provided as part of a first light source array 104a associated with a first circuit 404a. A CCD camera (the detector 316) was fitted with a Red Additive 590 nm Long Pass emission filter 312 to capture an image. In addition, an image of a Coomassie Blue stained 2D protein gel transilluminated by a device 100 of this invention showing the colorimeteric staining pattern of the chromophor dye bound to proteins in the gel was obtained. An image of a Coomassie Blue stained 1D protein gel transilluminated by a device of this invention showing the colorimeteric staining pattern of the chromophor dye bound to proteins in the gel was also obtained. In accordance with an embodiment of the present invention, the transillumination device 100 used in the present example also contains white incandescent light LEDs 112b included as part of a second light source array 104b associated with a second circuit 404b for viewing protein gels stained with the chromophors silver or Coomassie Blue. The two types of LEDs 112a-b are arranged in the interleaved printed circuit board layout illustrated in FIG. 6. The emission filter 312 can remain in place when viewing these chromophors. The transillumination system 300 of the present example comprises a device that automatically images gels placed on the transilluminator as shown in FIG. 6. White or blue LED selection and intensity is adjustable through software control implemented as part of the control 304.

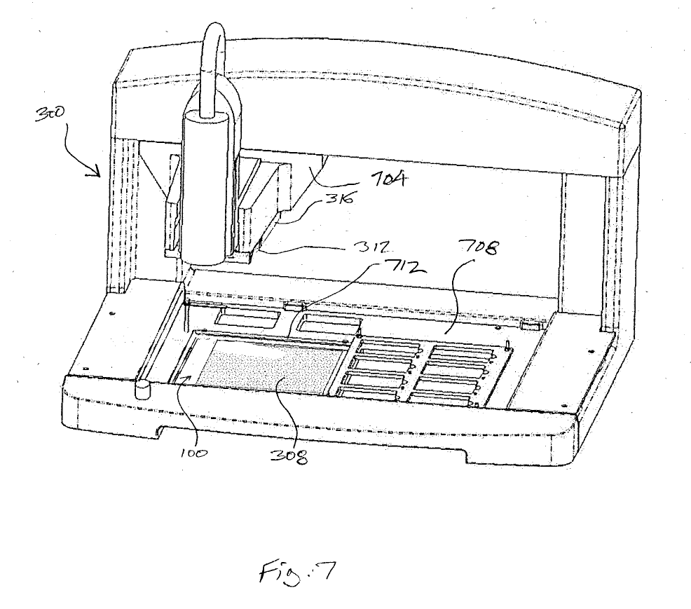

FIG. 7 shows a transillumination device 100 integrated into an automated gel processing system or transillumination system 300 in accordance with an embodiment of the present invention. The transillumination system 300 includes a detector 316 comprising a downward looking CCD camera. The CCD camera 316 can be selectively fitted with an emission filter 312. A carrier 704 allows the CCD camera 316 to be moved to a desired position over a platform 708. The platform 708 may be transparent and/or may have an aperture or window to allow illumination of a sample or samples 308. The platform 708 may also be configured to receive a tray 712 to which one or more biological substrates or slides comprising samples 308 may be attached. The tray 712 may be transparent and/or may be provided with a window or aperture to allow illumination of a sample or samples 308.

To view or detect fluorescence, the light source array or arrays 104 are comprised of LEDs 112 selected for emission peaks close to the excitation peaks of the dyes being measured and an emission filters 312 is placed between the sample 308 comprising the dye and the viewer or detector 316 while the substrate or sample 308 is illuminated by the transillumination device 100. The emission filter 312 is chosen to ensure that only the light of wavelengths emitted by the dye is passed to the viewer or detector 316. A different emission filter 312 may be used for different LED/dye combinations. By selecting LEDs 112 of a sufficiently narrow wavelength band, there is no need for an excitation filter in the described device. This also makes the selection of the type of emission filter 312 less critical. The good separation between excitation and emission wavelengths achievable using LED illumination produces images with extraordinarily large signal to noise ratios. The light source array or arrays 104 for viewing or detecting fluorescence may include LEDs 112 chosen to excite dyes with excitation peaks in the ultra-violet and/or visible spectrum.

To view or detect absorbance, the light source array or arrays 104 are comprised of LEDs 112 that emit wavelengths of light over all or part of the absorbance range of the dyes being measured. Incandescent white LEDs 112 may be used as well as single color LEDs 112 or multiple single color LEDs 112. Since the absorbance range of most dyes is broad, the selection of LEDs 112 for viewing absorbance is less critical than for fluorescence measurements. Ideally, the LEDs 112 emit light near the peak of absorbance for a specific dye. In many cases, the same LEDs 112 can be used for both fluorescence and absorbance measurements.

To view or detect light scattered by particles attached to biomolecules as stains, the light source array or arrays 104 are comprised of LEDs 112 that emit wavelengths of light scattered by the particles being measured. Incandescent white LEDs 112 may be used as well as single color LEDs 112 or multiple single color LEDs 112. Since the light scatter range of most particles is broad, the selection of LEDs for use in connection with light scatter measurements is less critical than for fluorescence measurements. In many cases, the same LEDs can be used for fluorescence, absorbance and light scatter measurements.

The dyes used in connection with samples 308 illuminated by the transillumination device 100 in accordance with an embodiment of the present invention may be any chemicals, stains, dyes, chromophors, fluorophors, colloidal silver, colloidal gold, nanoparticles or other substances bound to and used to visualize a pattern, structure, substrate or substance known or readily available to those skilled in the art, and are preferably used in the form of dyes bound to or in a biological sample. The dyes may be used to detect and quantify any desired substance to which they can be attached or into which they can be incorporated (e.g. proteins, nucleic acids, carbohydrates, fats, scaffolds, supramolecular structures, cells, tissues and organisms). Dyes may also be an intrinsic part of an organism or substance to be visualized or detected (i.e., occurs naturally rather than being artificially stained with an exogenously added dye).

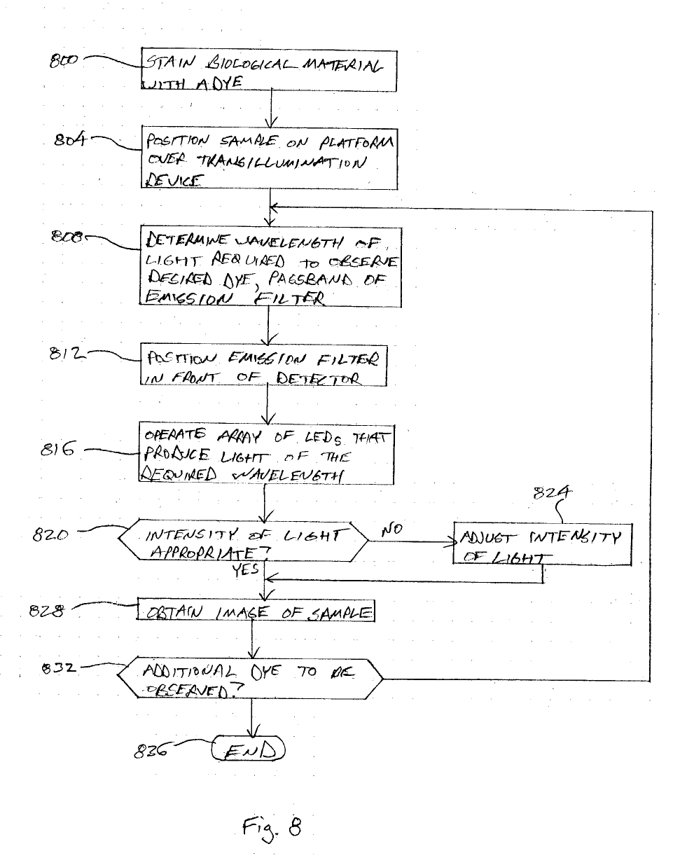

With reference now to FIG. 8, a flow chart illustrating a method for selectively viewing dyes within a sample 308 in accordance with an embodiment of the present invention is illustrated. Initially, at step 800, a sample of biological material is stained with a dye. As can be appreciated by one of skill in the art, the dye may selectively bind to particular materials within the sample of biological material. As can also be appreciated by one of skill in the art, a number of different dyes may be used in connection with a single sample of biological material. The staining process may include destaining to remove any unbound dye.

At step 804, the sample 308 is placed on the platform 708, such that light emitted by the transillumination device 100 is incident upon the sample 308. At step 808, the wavelength of light required in order to observe or view a desired dye or aspect of the desired dye, and the pass band of an emission filter 312 required to view that dye or aspect of the dye are determined. The emission filter 312 is then positioned in front of the detector 316 (step 812), and the light source array 104 having LEDs 112 that produce light at the required wavelength is operated (step 816). As described elsewhere herein, the selection of light source wavelength and emission filter pass band allows fluorescence, absorption, or scattering by material within the sample 308 to be viewed or detected.

At step 820, a determination is made as to whether the intensity of the light output by the selected LEDs 112 is appropriate. For example, when a number of different dyes within a sample are viewed or detected, the intensity of the image produced may vary. Accordingly, it may be desirable to normalize the intensity of the image, for example in order to facilitate a comparison of images of the different dyes. If the intensity of the light is not appropriate, the intensity of the light output may be varied, for example by providing a pulse width modulated control signal to the selected light source array 104 of LEDs 112 (step 824). After adjusting the intensity of the light output, or if no adjustment is required, the process proceeds to step 828.

At step 828, an image of the sample, and in particular of the dye or aspect of the dye being viewed or detected, is created. For example, a film photograph or digital image may be made of the illuminated sample 308. Alternatively, the sample 308 may be viewed by a human eye directly or through a microscope. In one aspect of the present invention, the detector 316 may obtain a complete image of the sample 308 at one time. In particular, because a transillumination device 100 in accordance with the present invention is capable of illuminating the entire area of a sample 308 simultaneously, there is no need to build an image through rastering or other techniques.

At step 832, a determination is made as to whether any additional dye within a sample 308 is to be viewed. If additional dyes are to be viewed, the process returns to step 808, at which the wavelength of the light required to view the desired dye and the pass band of the emission filter 312 are determined. After positioning the emission filter 312 in front of the detector 316 (step 816), the light source array 104 having LEDs 112 that provide light at the required wavelength may be operated (step 820). It should be noted that operation of a transillumination device 100 such that light at a second wavelength or range of wavelengths that is different from a first wavelength or range of wavelengths does not require changing an emission filter. Rather, a different light source array 104 of LEDs 112 capable of producing light at the required wavelength is selected. In addition, it should be noted that no excitation filter is used. Instead, the proper wavelength of excitation light is obtained by the use of LEDs that output light at the required wavelength or range of wavelengths. If no additional dyes are to be viewed, the process ends (step 836).

Tables 1 and 2 below provide examples of dyes used in protein studies, their excitation and emission ranges, and the corresponding LEDs and filters required to view them in accordance with embodiments of the present invention.

TABLE 1

| | Excitation (nm) | | Emission (nm) | |
|---|---|---|---|---|
| Dye | Range | Peak | Range | Peak |
| SYPRO Ruby | 370-530 nm | 470 nm | 550-720 nm | 610 nm |
| | 250-340 nm | 290 nm | 550-720 nm | 610 nm |
| SYPRO Tangerine | 380-560 nm | 470 nm | 560-750 nm | 645 nm |
| SYPRO Orange | 400-530 nm | 470 nm | 520-650 nm | 550 nm |
| SYPRO Red | 450-610 nm | 530 nm | 550-700 nm | 630 nm |
| Cy2 | 450-520 nm | 485 nm | 490-570 nm | 515 nm |
| Cy3 | 480-570 nm | 550 nm | 550-630 nm | 570 nm |
| Cy3B | na | 558 nm | 560-640 nm | 572/585 nm |
| Cy5 | 580-680 nm | 650 nm | 640-710 nm | 670 nm |
| Cy5.5 | na | 675 nm | 660-730 nm | 694 nm |
| Silver | na | na | na | na |
| Coomassie Blue | na | na | na | na |

TABLE 2

| Dye | LED | Emission Filter |
|---|---|---|
| SYPRO Ruby | 470 nm Super Blue | Red Additive |
| | | 590 nm Long Pass |
| SYPRO Tangerine | 470 nm Super Blue | Red Additive |
| | | 590 nm Long Pass |
| SYPRO Orange | 470 nm Super Blue | Green Additive |
| | | 490-580 nm |
| | | Band Pass |
| SYPRO Red | 525 nm InGaN Super Green | Red Additive |
| | λΔ36 | 590 nm Long Pass |
| Cy2 | 470 nm Super Blue | 520 nm λΔ10 |
| | 505 nm λΔ10 | Band Pass |
| Cy3 | 502 nm Blue Green | 568 nm λΔ10 |
| | λΔ30 | Band Pass |
| | 502 nm Blue Green | 580 nm λΔ10 |
| | λΔ30 | Band Pass |
| | 525 nm InGaN Super Green | 600 nm λΔ40 |
| | λΔ36 | Band Pass |
| Cy3B | 502 nm Blue Green | 568 nm λΔ10 |
| | λΔ30 | Band Pass |
| | 502 nm Blue Green | 580 nm λΔ10 |
| | λΔ30 | Band Pass |
| | 525 nm InGaN Super Green | 600 nm λΔ40 |
| | λΔ36 | Band Pass |
| Cy5 | 612 nm Orange | 671 nm λΔ10 |
| | λΔ17 | Band Pass |
| | | 676 nm λΔ10 |
| | | Band Pass |
| | | 650 nm |
| | | Long Pass |
| Cy5.5 | 650 nm Ultra Red | 700 nm λΔ40 |
| | λΔ20 | Band Pass |
| | | 694 nm λΔ10 |
| | | Band Pass |
| Silver | 470 nm + 525 nm | None |
| Coomassie Blue | 525 nm + 612 nm | None |

In an exemplary embodiment of the present invention, a transilluminator 100 is comprised of the following:

1) A light source circuit 400 containing three light source arrays 104, each light source array 104 having LEDs 112 of one of the following types:

a) 470 nm Super Blue

b) 525 nm InGaN Super Green

c) 612 nm Orange

2) Four emission filters 312:

| | |
|---|---|
| a) Red Additive | 590 nm Long Pass |
| b) Green Additive | 490-580 nm Band Pass |
| c) 515 nm Narrow | Band Pass |
| d) 568 nm Narrow | Band Pass |

Such a transillumination device 100 can be used to view most, if not all, of the dyes listed in Tables 1 and 2. Other configurations optimized for other dye sets are possible.

One feature of this exemplary embodiment is the ability to image fluorescence 2D differential electrophoresis gels (2D DIGE). 2D DIGE uses molecular weight- and charge-matched, spectrally resolvable dyes (e.g., Cy3(b) and Cy5) to label two different protein samples prior to 2D electrophoresis. By way of illustration, one protein sample may be isolated from cells treated in one way and the other protein sample isolated from cells treated in another way. One protein sample is labeled with a first dye and the other with a second dye. The samples are mixed and resolved on a single gel. The gel is imaged using two different excitation/emission pairs to view the pattern of fluorescence for each dye independently. Then the two images are aligned and the differences evaluated. By integrating such an embodiment into a gel imaging system, such as a transillumination system 300, it is possible under software control to automatically image the Cy3(b) stained proteins of a sample 308 using the 525 nm InGaN Super Green/568 nm Narrow Band Pass pair and then automatically switch to the 612 nm Orange/Red Additive 590 nm Long Pass pair to image the Cy5 stained proteins of that sample 308.

Based on the examples provided and the embodiments described, it should be understood that the multiwavelength transillumination system 300 as specifically described herein could be altered without deviating from its fundamental nature. For example, different LED light sources 112 and sets and types of filters 312 could be substituted for those exemplified and described herein, so long as the light reaching the light detector 316 contains sufficient information to allow viewing of an image of the pattern of absorbance, light scattering and fluorescence produced by the dyes being illuminated. As an additional example, the LEDs 112 could be positioned so that the light produced by the LEDs 112 impinged on a sample 308 from the side of the sample 308 facing the detector 316. For instance, the LEDs 112 could be arranged in a ring surrounding the detector 316. In accordance with the present invention, certain embodiments may allow detection and quantification of the amount of absorbance, light scattering and fluorescence produced by the dyes being illuminated. It is therefore to be understood that within the scope of the appended claims, the invention may be practiced in ways other than as specifically described herein.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. A transilluminator, comprising:
a first light source array, including at least a first LED operable to output light within a first range of wavelengths;
a second light source array, including at least a second LED operable to output light within a second range of wavelengths;
a control, wherein at least a selected one of said first light source array and said second light source array is operated to output light.

2. The transilluminator of claim 1, wherein said control comprises a switch.

3. The transilluminator of claim 1, wherein said control is operable to modulate an intensity of light output from said selected one of said first light source array and said second light source array.

4. The transilluminator of claim 3, wherein said control provides a pulse width modulated signal to said selected one of said first light source array and said second light source array.

5. The transilluminator of claim 1, wherein light is output from both said at least a first LED and said at least a second LED simultaneously.

6. The transilluminator of claim 1, wherein said first light source array comprises a plurality of said first LEDs and said second light source array comprises a plurality of said second LEDs.

7. The transilluminator of claim 6, wherein said first LEDs of said first light source array are interleaved with said second LEDs of said second light source array.

8. The transilluminator of claim 6, wherein said first light source array comprises said first LEDs arranged in rows, wherein said second light source array comprises said second LEDs arranged in rows, wherein each row of said first light source array is adjacent at least one row of said second light source circuit.

9. The transilluminator of claim 1, further comprising:
a diffuser, wherein light output from said first and second LEDs is diffused.

10. The transilluminator of claim 1, further comprising:
a printed circuit board, wherein said first LED of said first light source array and said second LED of said second light source array comprise circuits formed on said printed circuit board.

11. The transilluminator of claim 1, further comprising:
a third light source array comprising at least a third LED.

12. The transilluminator of claim 11, wherein said first LED produces light having a wavelength of about 470 nm, wherein said second LED produces light having a wavelength of about 525 nm, and wherein said third LED produces light having a wavelength of about 612 nm.

13. A method for illuminating biological substrates, comprising:
outputting first light having a wavelength within a first range from at least a first LED, wherein said first light is incident upon a first sample, and wherein said light at least one of a) excites a fluorescent dye within said sample, b) is absorbed by a dye within said sample, and c) is scattered by a dye within said sample;
outputting second light having a wavelength within a second range from at least a second LED, wherein said second light is incident upon at least one of said first sample and a second sample, and wherein said light at least one of a) excites a fluorescent dye within said sample, b) is absorbed by a dye within said sample, and c) is scattered by a dye within said sample;

14. The method of claim 13, further comprising:
varying an intensity of at least one of said first light and said second light.

15. The method of claim 14, wherein varying an intensity of said at least one of said first light and said second light comprises providing a pulse width modulated signal to said at least one of said first LED and said second LED.

16. The method of claim 13, wherein said step of outputting first light comprises outputting light from a plurality of LEDs.

17. The method of claim 13, wherein said step of outputting second light comprises outputting light from a plurality of LEDs.

18. The method of claim 13, further comprising:
passing said first light and said second light through a diff-user before said first and second light is incident upon at least said first sample.

19. The method of claim 13, further comprising passing said first light that at least one of a) excites a fluorescent dye within said sample, b) is absorbed by a dye within said sample, and c) is scattered by a dye within said sample through a first filter.

20. The method of claim 13, further comprising:
passing said first light that at least one of a) excites a fluorescent dye within said sample, b) is absorbed by a dye within said sample, and c) is scattered by a dye within said sample through a first filter;
passing said second light that at least one of at least one of: a) excites a fluorescent dye within said sample, b) is absorbed by a dye within said sample, and c) is scattered by a dye within said sample through a second filter.

21. A transilluminator, comprising:
means for generating light having a first wavelength, wherein said means for generating light having a first wavelength includes at least a first LED;
means for generating light having a second wavelength, wherein said means for generating light having a second wavelength includes at least a second LED;
means for positioning a sample of biological material within said light having said first wavelength and said light having a second wavelength.

22. The transilluminator of claim 21, further comprising:
means for controlling an intensity of at least one of said light having a first wavelength and said light having a second wavelength.

23. The transilluminator of claim 21, further comprising:
means for detecting at least one of fluorescence, scattering, and absorption of at least one of said light having a first wavelength and said light having a second wavelength.

24. The transilluminator of claim 21, further comprising:
means for diffusing said light having a first wavelength and said light having a second wavelength.

25. The transilluminator of claim 21, further comprising:
means for positioning a sample of biological material comprises means for positioning a number of samples of biological material.
